(19) United States
(12) Patent Application Publication
(10) Pub. No.: US 2024/0164536 A1
(43) Pub. Date: May 23, 2024

(54) SPRING POCKET, SPRING CUSHION, FURNITURE AND METHOD OF MANUFACTURING THE SPRING POCKET

(71) Applicant: NEW-TEC INTEGRATION (XIAMEN) CO., LTD., Xiamen (CN)

(72) Inventor: Luhao LENG, Xiamen (CN)

(21) Appl. No.: 18/551,163

(22) PCT Filed: Apr. 26, 2022
(86) PCT No.: PCT/CN2022/089333

§ 371 Date: Sep. 18, 2023

(30) Foreign Application Priority Data
Apr. 30, 2021 (CN) 202110485098.4

(51) Int. Cl. A47C 27/06

(52) U.S. Cl. CPC A47C 27/064

(57) ABSTRACT

A spring pocket includes a conical spring having a large-diameter end and a small-diameter end opposite to the large diameter end, and a flexible bag. The flexible bag includes an outer layer and an inner layer joined at the large-diameter end and the small-diameter end to encapsulate the conical spring in the flexible bag. The sheets for producing the flexible bag are produced in a single step. Even though the sheets have a large machining tolerance, since the two sheets are identical, they may still match each other and can be easily overlapped and joined.

### FIELD

The present invention relates to the field of furniture, and more specifically to a spring pocket, a spring cushion, furniture and a method of manufacturing the spring pocket.

### BACKGROUND

Conventional furniture such as beds and sofas usually have elastic cushion, which are generally formed of a plurality of superposed layers and springs to provide a comfortable sitting and lying experience.

A cushion with individually pocketed springs is already known in which each spring is individually enclosed in a bag or pocket and a plurality of spring pockets are arranged in a predetermined pattern so as to form a spring pocket set. Then, a whole piece of foam rubber covers the outside of the spring pocket set by adhesion, bonding, etc., to form a desired spring cushion. In this way, the springs can bend individually without affecting other surrounding springs, and the users' weight can be distributed more evenly, thereby reducing mutual influence when two or more users sit or lie on the spring cushion (e.g., if weight difference between the users is relative large, other user(s) will be certainly affected when one of them turns over or moves on the spring cushion). Therefore, the users' comfort in use is enhanced.

At present, upon processing and designing the spring bag, it's necessary to provide a plurality of parts having different sizes and structures according to the structure of the spring. These parts are assembled together to form the spring bag, and then the spring is encapsulated in the spring bag. Such a production mothed requires too many processing steps and causes low production efficiency. In addition, since the parts are produced individually during different process, when the sizes and structures have excessive errors, it's prone to mismatch in size or structure between different parts due to large machining tolerance such that these part cannot be well assembled, thereby causing a low qualification ratio and a waste of resources and manpower.

Therefore, it is necessary to provide a spring pocket, a spring cushion, furniture and a method of manufacturing the spring pocket to at least partially solve the above problems.

### SUMMARY

A main object of the present invention is to provide a spring pocket, a spring cushion having the spring pocket, furniture and a method of manufacturing the spring pocket. Regarding the spring pocket of the present invention, the flexible bag is formed by overlapping two completely identical flexible sheets and jointing corresponding edges of the two flexible sheets. This may simplify the production process, and particularly may omit steps of making different parts having different sizes or structures, thereby improving the production efficiency. The sheets for making the flexible bag are produced in a single step. Even though the sheets have a large machining tolerance as compared with a normal size or structure, since the two sheets are completely identical, they may still match each other and can be easily overlapped and jointed, which helps to reduce the effect caused by machining tolerance and to improve the production qualification ratio.

According to a first aspect of the present invention, there is provided a spring pocket for producing a spring cushion of furniture, comprising:
a conical spring having a large-diameter end and a small-diameter end opposite to the large-diameter end; and
a flexible bag comprising an outer layer located at an outer side of the conical spring and an inner layer located at an inner side of the conical spring, the outer layer and the inner layer being jointed at the large-diameter end and the small-diameter end respectively, thereby encapsulating the conical spring in the flexible bag,
wherein the flexible bag is formed by overlapping the first flexible sheet and the second flexible sheet which are completely identical to each other and jointed them at corresponding edges.

In some embodiments, the first flexible sheet and the second flexible sheet are both in a circular shape, and the first flexible sheet, the conical spring and the second flexible sheet are arranged in an axial direction of the conical spring, wherein outer edges of both the first flexible sheet and the second flexible sheet are jointed at a radially outer side of the large-diameter end, and the parts of both the first flexible sheet and the second flexible sheet close to a center thereof are jointed at a radially inner side of the small-diameter end.

In some embodiments, the joint of the first flexible sheet and the second flexible sheet is completed in a state in which the conical spring is axially compressed.

In some embodiments, both the first flexible sheet and the second flexible sheet are both in a shape of convex hexagon having at least one pair of first edge and second edge which are opposite and parallel to each other, the conical spring is wrapped between the first flexible sheet and the second flexible sheet, the small-diameter end faces the first edge, the second edge enters the inner side of the conical spring around the large-diameter end from the outer side of the conical spring and is jointed to the first edge at the small-diameter end.

In some embodiments, in the shape of convex hexagon, angles between the first edge and two adjacent edges of the first edge are equal, and a sum of the angles is equal to a straight angle pluses a half of a central angle of a sector or a sector-like shape formed when a side surface of the conical spring is developed.

In some embodiments, a joint seam of the first flexible sheet and the second flexible sheet is located in the inner side of the flexible bag.

In some embodiments, at least the joint connecting the second edges is formed following a step of the conical spring being wrapped by the first flexible sheet and the second flexible sheet.

In some embodiments, the joint of the outer layer and the inner layer at the small-diameter end forms an annular joint portion located at radially inner side of the small-diameter end and extending circumferentially the small-diameter end.

In some embodiments, the flexible bag is formed by jointing the flexible sheets by means of sewing or ultrasonic welding.

In some embodiments, the flexible bag is made of a non-woven fabric.

According to a second aspect of the present invention, there is also provided a spring cushion for producing furniture, the spring cushion comprising a plurality of the above-mentioned spring pockets. The spring cushion is particularly a mattress.

According to a third aspect of the present invention, there is also provided furniture comprising the above-mentioned spring cushion, and/or the above-mentioned spring pocket.

According to a fourth aspect of the present invention, there is also provided a method of manufacturing a spring pocket used to form a spring cushion for furniture, which comprises the steps of:
arranging a first flexible sheet, a conical spring and a second flexible sheet in an axial direction of a conical spring, wherein the first flexible sheet and the second flexible sheet are both in a circular shape and completely identical to each other;
axially compressing the conical spring and causing the first flexible sheet and the second flexible sheet to contact at least at their edges;
jointing the first flexible sheet and the second flexible sheet at a radially outer side of a large-diameter end and a radially inner side of a small-diameter end of the conical spring, respectively;
decompressing the conical spring so that one of the first flexible sheet and the second flexible sheet wraps the conical spring at an outer side of the conical spring and forms an outer layer, and the other of the first flexible sheet and the second flexible sheet wraps the conical spring at an inner side of the conical spring and forms an inner layer.

According to the fifth aspect of the present invention, there is also provided another method of manufacturing a spring pocket used to form a spring cushion for furniture, the method comprising the steps of:
overlapping a first flexible sheet and a second flexible sheet in contact with each other, wherein the first flexible sheet and the second flexible sheet are both in a shape of convex hexagon and are completely identical to each other, and the shape of convex hexagon has at least one pair of first edge and second edge, which are opposite and parallel to each other;
at least jointing corresponding first edges and two edges adjacent to the first edges of the first flexible sheet and the second flexible sheet, while leaving at least the second edges not jointed;
turning a cloth bag formed by the first flexible sheet and the second flexible sheet inside out;
placing a conical spring into the cloth bag with a small-diameter end of the conical spring facing the first edge;
jointing the edges of the first flexible sheet and the second flexible sheet which have not been jointed;
tucking the second edges around a large-diameter end of the conical spring into the inner side of the conical spring;
jointing the first edge to the second edge at the small-diameter end.

### BRIEF DESCRIPTION OF THE DRAWINGS

Reference may be made to preferred embodiments shown in the figures to enable better understanding of the above and other objects, features, advantages and functions of the present invention. The same reference numerals in the figures denote the same parts. Those skilled in the art should appreciate that the figures are intended to schematically illustrate the preferred embodiments of the present invention, and not intended to impose any limitations to the scope of the present invention. All parts in the figures are not drawn to scale.

FIG. 1 exemplarily shows a perspective view of a spring pocket according to a first embodiment of the present invention.

FIG. 2 exemplarily shows a vertical sectional view of the spring pocket shown in FIG. 1.

FIG. 3 through FIG. 6 exemplarily show a process of manufacturing the spring pocket shown in FIG. 1.

FIG. 7 exemplarily shows a schematic diagram of a first (second) flexible sheet for making a flexible bag of the spring pocket shown in FIG. 1.

FIG. 8 exemplarily shows a top view of a structure corresponding to the step shown in FIG. 5 in the productive process of the spring pocket.

FIG. 9 exemplarily shows a perspective view of a spring pocket according to a second embodiment of the present invention.

FIG. 10 through FIG. 15 exemplarily show a process of manufacturing the spring pocket shown in FIG. 9.

FIG. 16 exemplarily shows a schematic diagram of a first (second) flexible sheet for making a flexible bag of the spring pocket shown in FIG. 9.

FIG. 17 exemplarily shows another configuration of a first (second) flexible sheet for making the flexible bag of the spring pocket shown in FIG. 9.

### DETAILED DESCRIPTION OF EMBODIMENTS

Specific embodiments of the present prevention will now be described in detail with reference to the figures. What are described here are only preferred embodiments according to the present invention. Those skilled in the art can implement other embodiments of the present invention on the basis of the preferred embodiments, and said other embodiments also fall within the scope of the present invention.

The present invention provides a spring pocket for producing an elastic cushion of furniture such as beds and sofas.

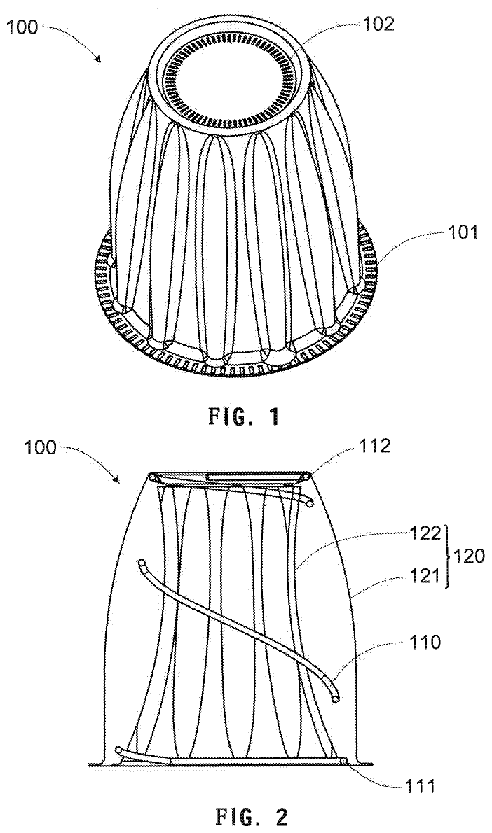

FIG. 1 and FIG. 2 show a spring pocket 100 according to a first embodiment which comprises a conical spring 110 and a flexible bag 120. In the illustrated embodiment, the conical spring 100 is configured as a frustoconical shape having a large-diameter end 111 and a small-diameter end 112 opposite to the large-diameter end 111. It may be appreciated that conical springs constructed in other shapes, such as truncated square cones or truncated polygonal pyramids, etc., may also be used in spring pockets according to the present invention. The flexible bag 120 is used to encapsulate the conical spring 110. The flexible bag 120 has a double-layer structure including an outer layer 121 that wraps the conical spring 110 at an outer side thereof and an inner layer 122 that is located at an inner side of the conical spring 110 and wraps the conical spring 110 at the inner side. The outer layer 121 and the inner layer 122 are jointed at the large-diameter end 111 and the small-diameter end 112 of the conical spring 110 to form a one-piece flexible bag 120 to encapsulate the conical spring 110 therein.

According to the present invention, the flexible bag is formed by overlapping two completely identical flexible sheets and jointing corresponding edges of the two flexible sheets. The two flexible sheets may be referred to as a first flexible sheet and a second flexible sheet. The flexible sheets for producing the flexible bag has only one size and structure. Therefore, in the actual production process, the flexible sheet can be produced in a single process, thereby reducing the processing steps and improving the production efficiency. Moreover, since the flexible sheets are produced in a single process, all the flexible sheets have substantial same machining tolerance, thus ensuring that all the flexible sheets can overlap with each other and their corresponding edges may be jointed regardless of the level of tolerance. Therefore the case in which different parts for producing the flexible bag cannot be assembled due to different machining tolerances can be avoided and product qualification ratio can be improved.

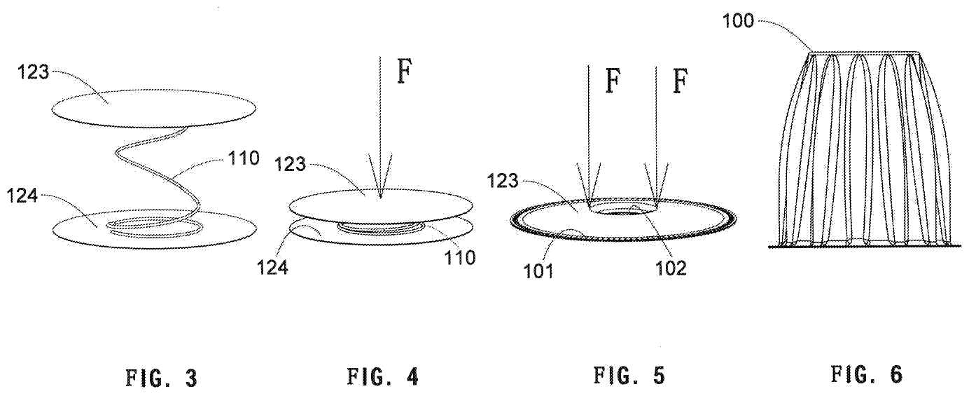

A process of manufacturing the spring pocket according to the present invention will be described in detail below with reference to FIG. 3 through FIG. 8.

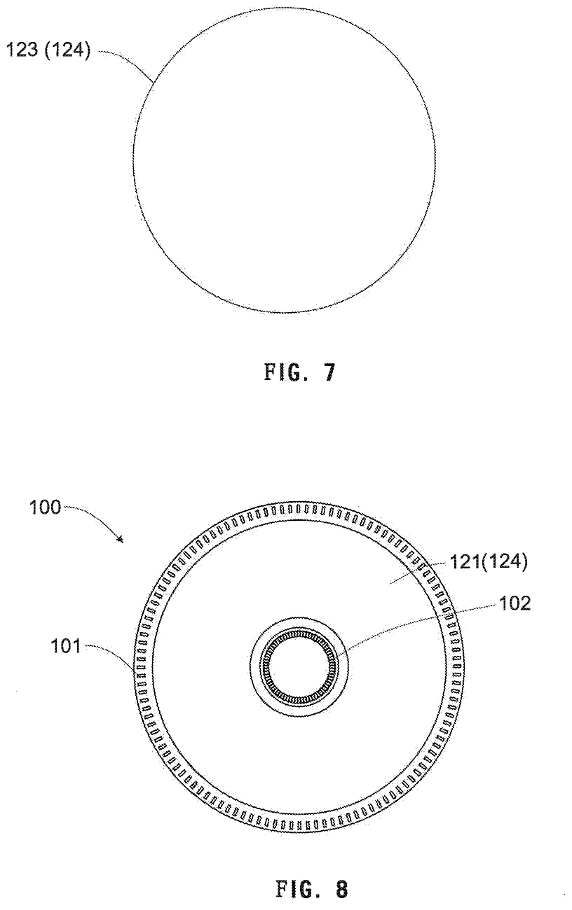

As shown in FIG. 7, in the first embodiment, a first flexible sheet 123 and a second flexible sheet 124 for producing the flexible bag 120 are both in a circular or approximately circular shape, and can be made of a non-woven fabric.

Upon manufacturing the spring pocket, firstly, the first flexible sheet 123, the conical spring 110 and the second flexible sheet 124 are arranged in a manner shown in FIG. 3 along an axial direction of the conical spring 110. The first flexible sheet 123 corresponds to the small-diameter end 112 of the conical spring 110, and the second flexible sheet 124 corresponds to the large-diameter end 111 of the conical spring 110. The first flexible sheet 123 and the second flexible sheet 124 overlap with each other as viewed in the axial direction.

Then, as shown in FIG. 4, a pressure F along the axial direction is applied to the conical spring 110, so that the conical spring 110 is axially compressed until it is flattened, i.e. the small-diameter end 112 substantially reaches the large-diameter end 111. By doing so, the first flexible sheet 123 and the second flexible sheet 124 can be in contact with each other at least at their edges.

Then, as shown in FIG. 5 and FIG. 8, the edges of both the first flexible sheet 123 and the second flexible sheet 124 are jointed to form a first joint portion 101 which is located at radially outer side of the large-diameter end 111 of the conical spring 110. Furthermore, a second joint portion 102 is formed by jointing parts of both the first flexible sheet 123 and the second flexible sheet 124 close to a center thereof. The second joint portion 102 is located at radially inner side of the small-diameter end 112 of the conical spring 110. Preferably, the second joint portion 102 is configured as an annular joint portion extending in a circumferential direction of the small-diameter end 112. In this way, the joint formed at the small-diameter end 112 can be as close to the conical spring 110 as possible, which help the flexible bag 120 to stably retain the conical spring 110. Preferably, the joint between the first flexible sheet 123 and the second flexible sheet 124 may be achieved by means of sewing or ultrasonic welding.

Furthermore, as shown in FIG. 6, when the joint is completed, the axial pressure F applied to the conical spring 110 is released, so that the conical spring 110 returns to its original shape. In this way, the production of the spring pocket 100 is hereby completed. In the first embodiment, the flexible sheet corresponding to the small-diameter end 112 of the conical spring 110 wraps the outer side of the conical spring 110, and forms the outer layer 121 of the flexible bag 120 by itself; After the conical spring 110 returning to its original shape, due to the pulling action of the second joint portion 102, the flexible sheet corresponding to the large-diameter end 111 of the conical spring 110 enters into the inner side of the conical spring 110 and wraps the conical spring 110 at the inner side, forming the inner layer 122 of the flexible bag 120 by itself. As shown in FIG. 1, FIG. 2 and FIG. 6, since the flexible sheets are circular, after the conical spring 110 returning to its original shape, wrinkles substantially extending along a generatrix of the conical spring 110 are formed on both the outer layer 121 and the inner layer 122.

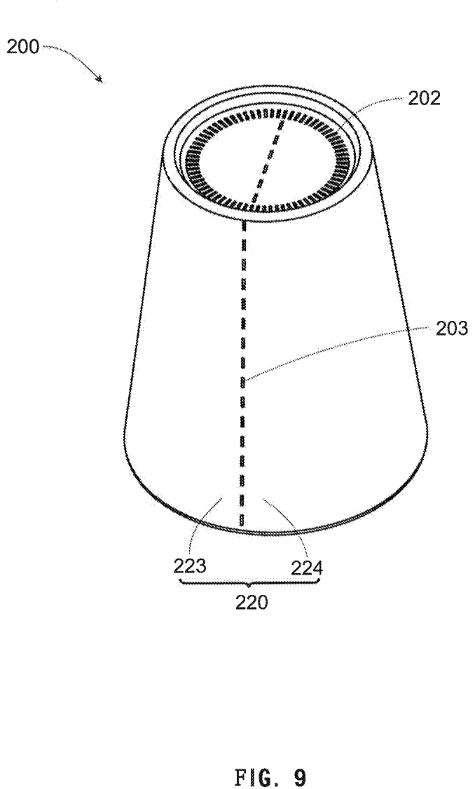

FIG. 9 through FIG. 17 exemplarily show a spring pocket 200 according to a second embodiment and a process of manufacturing the same. The spring pocket 200 according to the second embodiment is substantially the same as the spring pocket 100 according to the first embodiment in structure. The difference lies in the structure of flexible bag as well as how to produce it. Detailed introduction will be presented with reference figures.

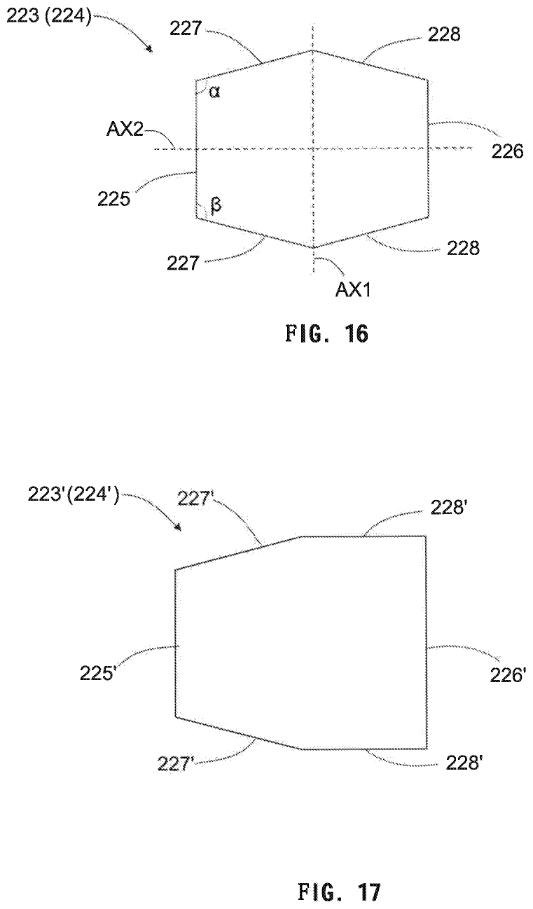

As shown in FIG. 16, according to the second embodiment, the flexible sheets for making the flexible bag (i.e., a first flexible sheet 223 and a second flexible sheet 224) are substantially in a shape of convex hexagon having at least one pair of edges which are opposite and parallel to each other, namely, a first edge 225 and a second edge 226, and two first adjacent edges 227 adjacent to the first edge 225 and two second adjacent edges 228 adjacent to the second edge 226.

Preferably, the first flexible sheet 223 and the second flexible sheet 224 may each be configured as a symmetrical shape. That's to say, they are symmetrical about a line (namely, a dashed line AX1 in FIG. 16) connecting intersection points of the first adjacent edges 227 and the second adjacent edges 228, and also symmetrical about a line (namely, a dashed line AX2 in FIG. 16) passing by midpoints of the first edge 225 and second edge 226 and being perpendicular to the first edge 225 and second edge 226. Under this circumstance, the first edge 225 and the second edge 226 are the same one edge and thereby are interchangeable. And the first adjacent edge 227 and the second adjacent edge 228 the same one edge and are interchangeable as well. Therefore, the relative placement angles for overlapping the two flexible sheets are not unique. In the illustrated embodiment, there are two relative placement angles that allow the two flexible sheets to overlap. While when the flexible sheet is in regular hexagonal shape, there would be six relative placement angles for overlapping placement. With this configuration, the two flexible sheets can overlap each other more easily, which is more convenient for processing.

Preferably, each of the two first adjacent edges 227 respectively forms an obtuse angle with the first edge 225. Angles α and β between the two first adjacent edges 227 and the first edge 227 are equal, and a sum of the two angles α and β is equal to a straight angle pluses a half of a central angle of a sector (or a sector-like shape, corresponding to the truncated square cone or truncated polygonal pyramid) formed when the side surface of the conical spring 210 is developed. In this way, when the flexible sheet forms the flexible bag 220, the first adjacent edges 227 coincide with the generatrix of the conical spring 210, which facilitates better fitting of the flexible bag 220 and the conical spring 210.

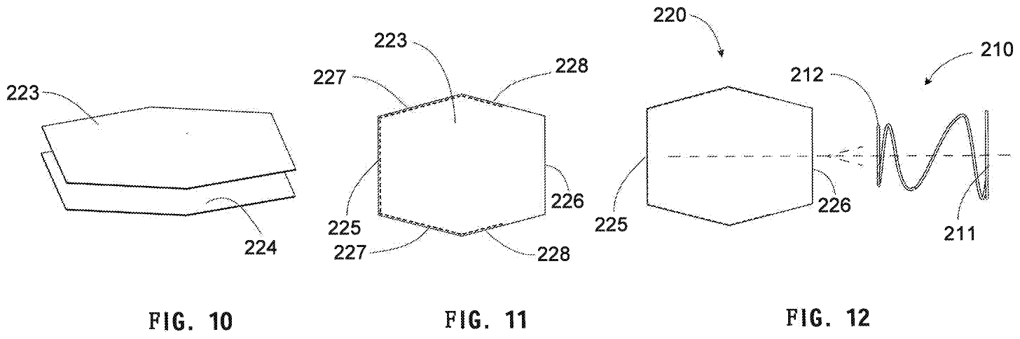

Upon manufacturing the spring pocket according to the second embodiment, firstly, the first flexible sheet 223 and the second flexible sheet 224 are arranged to overlap with each other as shown in FIG. 10.

Then, as shown in FIG. 11, the respective first edges 225 and first adjacent edges 226 of both the first flexible sheet 223 and the second flexible sheet 224 are jointed. Meanwhile, the second edges 226 are not jointed. For the second adjacent edges 228, they may be selectively jointed or not jointed or partially jointed. Those skilled in the art may choose flexibly according to actual process requirements. In the illustrated embodiment, portions of the second adjacent edges 228 proximate to the first adjacent edges 227 are jointed while portions of the second adjacent edges 228 proximate to the second edges 226 are left not jointed. Through the step shown in FIG. 11, the first flexible sheet 223 and the second flexible sheet 224 substantially constitute a cloth bag.

Further, as shown in FIG. 12, the cloth bag formed in the step shown in FIG. 11 is turned inside out, so that the joint seam between the first flexible sheet 223 and the second flexible sheet 224 is located at inner side of the cloth bag. After turning inside out, the conical spring 210 is placed into the cloth bag with a small-diameter end 212 facing the first edge 225.

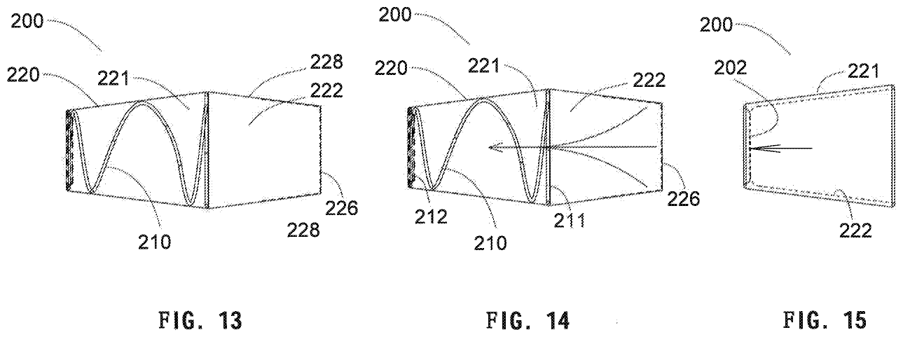

Then, as shown in FIG. 13, the sides of the first flexible sheet 223 and the second flexible sheet 224 which are not jointed, that is, portions of the second adjacent edges 228 approximate to the second edges 226 are jointed to the second edges 226. Thus, the conical spring 210 is encapsulated inside the cloth bag. At this time, it will be appreciated that the part wrapping an outer side of the conical spring 210 constitutes the outer layer 221 of the flexible bag 220. This part corresponds to the part encompassed by the first edges 225, the two first adjacent edges 227 and the dotted line AX1 in FIG. 16.

Furthermore, as shown in FIG. 14, the second edges 226 are tucked into the inner side of the conical spring 210 around the large-diameter end 211 from the outer side of the conical spring 210. Further as shown in FIG. 15, the first edge 225 and the second edge 226 are jointed at the small-diameter end 212 of the conical spring 210 to form the second joint portion 202 located at radially inner side of the small-diameter end 212. It can be seen that the part entering the inner side of the conical spring 210 along with the second edge 226 constitutes the inner layer 222 of the flexible bag 220. This part corresponds to the part encompassed by the second edges 226, the two second adjacent edges 228 and the dotted line AX1 in FIG. 16.

Unlike the spring pocket 100 according to the first embodiment, in the second embodiment, the outer layer 221 and the inner layer 222 of the flexible bag 220 are constituted by both portions of the first flexible sheet 223 and the second flexible sheet 224, a joint portion 203 as shown in FIG. 16 is formed between the two flexible sheets. The outer layer 221 and the inner layer 222 are connected at the large-diameter end 211 of the conical spring 210 by the material of the flexible sheet itself, and connected at the small-diameter end 212 by the second joint portion 202. The second joint portion 202 is formed as an annular joint portion located at radially inner side the small-diameter end 212 and extending along a circumferential direction of the small-diameter end 212. In addition, since the flexible bag 220 is formed in a state in which the conical spring 210 is not compressed, the outer layer 221 and the inner layer 222 of the flexible bag 220 are not wrinkled, but are formed with smooth surfaces.

FIG. 17 shows another configuration of the flexible sheet for producing the flexible bag in a second embodiment. A first edge 225′ and first adjacent edges 227′ of the flexible sheet 223′ (224′) have the same configuration as shown in FIG. 16. The difference lies in that second adjacent edges 228′ are substantially perpendicular to a second edge 226′. With such an arrangement, the second edge 226′ has a larger size. Therefore, in the step shown in FIG. 12, an opening of the cloth bag formed by the uncoupled second edges 226′ may have a larger size so that the conical spring 210 may be more easily placed into the cloth bag. However, in this configuration, the flexible sheet 223′ (224′) is not symmetrical about the line connecting the intersection points of the first adjacent edges 227′ and the second adjacent edges 228′. Therefore, it may be appreciated that there is only one positioning between the first flexible sheet 223′ and the second flexible sheet 224′, and between the first edges 225′ and the second edge 226′ and the conical spring 210. Of course, other configurations are also possible, for example, the angle formed by the second adjacent edges and the second edge may be an obtuse angle or even an acute angle.

In addition, those skilled in the art may understand that, in the second embodiment, the materials and coupling manner of the flexible bags may be the same as those described in the first embodiment.

According to a second aspect of the present invention, there is further provided an spring cushion for producing furniture, which is particularly a spring mattress. The spring cushion may consist of a plurality of superimposed layers (for example, the layers may include a sponge) and the spring pocket as described above. For example, the spring pocket may be assembled and fixed on a base structure to form an elastic module, a plurality of elastic modules are fixed on a mounting frame in a predetermined array through a structure such as a slide rail, and then superimposed layers including a sponge are laid on the array of elastic modules, and the spring cushion is formed.

According to a third aspect of the present invention, there is also provided a furniture which may have the spring cushion (which is particularly a mattress) as described above and/or the spring pocket as described above.

The spring cushion and furniture according to the present invention may obtain the same technical effect as the spring pocket according to the present invention.

The above depictions of various embodiments of the present invention are provided to those having ordinary skill in the art for a depiction purpose, and are not intended to exclude other embodiments from the present prevention or limit the present prevention to a single disclosed embodiment. As described above, various alternatives and modifications of the present prevention will be apparent to those of ordinary skill in the art. Accordingly, although some alternative embodiments have been described in detail, those having ordinary skill in the art will understand or readily develop other embodiments. The prevention is intended to cover all alternatives, modifications and variations of the present prevention described herein, as well as other embodiments falling within the spirit and scope of the present prevention described herein.

I/we claim:

1. A spring pocket for producing a spring cushion of furniture, comprising:
a conical spring having a large-diameter end and a small-diameter end opposite to the large-diameter end;
a flexible bag comprising an outer layer on an outer side of the conical spring and an inner layer on an inner side of the conical spring, the outer layer and the inner layer joined at the large-diameter end and the small-diameter end, respectively, thereby encapsulating the conical spring in the flexible bag;
the flexible bag formed by overlapping a first flexible sheet and an identical second flexible sheet and joining them at corresponding edges.

2. The spring pocket of claim 1 wherein the first and second flexible sheets are circular, and the first flexible sheet, the conical spring and the second flexible sheet are perpendicular to an axial direction of the conical spring;
wherein outer edges of the first and second flexible sheets are joined at a radially outer side of the large-diameter end, and a part of each of the first and second flexible sheets adjacent to a center of them are joined at a radially inner side of the small-diameter end.

3. The spring pocket of claim 2 wherein the joint of the first and second flexible sheets is completed with the conical spring axially compressed.

4. The spring pocket of claim 1 wherein the first and second flexible sheets are in a shape of convex hexagon having at least one pair of first and second edges opposite and parallel to each other, the conical spring wrapped between the first and second flexible sheets, with the small-diameter end facing the first edge and the second edge entering into the inner side of the conical spring around the large-diameter end from the outer side of the conical spring and joined to the first edge at the small-diameter end.

5. The spring pocket of claim 4 wherein angles (α, β) between the first edge and third and fourth edges adjacent to the first edge are equal, and a sum of the angles (α, β) is equal to a straight angle plus one half of a central angle of a sector or a sector-like shape formed when a side surface of the conical spring (210) is developed.

6. The spring pocket of claim 4 wherein a joint seam of the first flexible sheet and the second flexible sheet is located in the inner side of the flexible bag.

7. The spring pocket of claim 4 wherein at least the joint connecting the second edges is formed following a step of the conical spring being wrapped by the first flexible sheet and the second flexible sheet.

8. The spring pocket of claim 1 wherein the joint of the outer layer and the inner layer at the small-diameter end forms an annular joint portion located at the radially inner side of the small-diameter end and extending circumferentially around the small-diameter end.

9. The spring pocket of claim 1 wherein the flexible bag is formed by joining the flexible sheets by sewing or ultrasonic welding.

10. The spring pocket of claim 1 wherein the flexible bag comprises a non-woven fabric.

11. A spring cushion for producing furniture, wherein the spring cushion comprises a plurality of spring pockets of claim 1.

12. Furniture comprising a spring cushion of claim 11.

13. A method of manufacturing a spring pocket used to form a spring cushion for furniture, comprising:
arranging a first flexible sheet, a conical spring and a second flexible sheet in an axial direction of a conical spring, wherein the first and second flexible sheets are round and of equal size;
axially compressing the conical spring and causing at least edges of the first flexible and second flexible sheets to contact each other;
joining the first and second flexible sheets together radially outside of a large-diameter end of the conical spring and radially inside side of a small-diameter end of the conical spring; and
decompressing the conical spring so that the first flexible sheet wraps an outer side of the conical spring and the second flexible sheet wraps an inner side of the conical spring.

14. A method of manufacturing a spring pocket used to form a spring cushion for furniture, comprising:
overlapping a first and second flexible sheets and placing them into contact with each other, wherein the first and second flexible sheets have the same size and have a convex hexagon shape including at least one pair of first edge (225, 225′) and second edge (226, 226′) which are opposite and parallel to each other;
joining at least corresponding first edges (225, 225′) and two edges (227, 227′) adjacent to the first edges of the first flexible sheet (223, 223′) and the second flexible sheet (224, 224′), while leaving at least the second edges (226, 226′) un-joined;
turning a cloth bag formed by the first flexible sheet and the second flexible sheet inside out;
placing a conical spring into the cloth bag with a small-diameter end of the conical spring facing the first edge;
joining the un-joined edges of the first flexible sheet (223, 223′) and the second flexible sheet (224, 224′);
tucking the second edges (226, 226′) around a large-diameter end (211) of the conical spring (210) into an inner side of the conical spring (210); and
joining the second edge (226, 226′) to the first edge (225, 225′) at the small-diameter end (212).
